(19) United States
(12) Patent Application Publication
(10) Pub. No.: US 2026/0154628 A1
(43) Pub. Date: Jun. 4, 2026

(54) CAMPSITE RESERVATION SYSTEM USING ELECTRONIC SIGNPOSTS

(71) Applicant: Set Your Sites, Inc., Lincoln, NE (US)

(72) Inventors: Stacy Dam, Lincoln, NE (US); Dustin Dam, Lincoln, NE (US)

(21) Appl. No.: 19/408,680

(22) Filed: Dec. 4, 2025

Related U.S. Application Data
(60) Provisional application No. 63/727,923, filed on Dec. 4, 2024.

(51) Int. Cl. G06Q 10/02; G06Q 20/32

(52) U.S. Cl. CPC G06Q 10/0285; G06Q 20/322

(57) ABSTRACT

A campsite management system may include signposts located in a campground with multiple campsites, where each signpost provides a site-specific address for associated campsites. The system may include a registration controller to track registration statuses for all campsites. The registration controller may receive requests from users' mobile devices including the site-specific address, transmit the registration statuses of associated campsites to the mobile device, and updates registration statuses based on requests received from the mobile device.

### CROSS-REFERENCE TO RELATED APPLICATIONS

The present application claims the benefit under 35 U.S.C. § 119(e) of U.S. Provisional Application Ser. No. 63/727,923 filed on Dec. 4, 2024, which is incorporated herein by reference in the entirety.

### TECHNICAL FIELD

The present disclosure relates generally to a system providing campsite reservations and, more particularly, to a system providing electronic signposts for managing campsite reservations.

### BACKGROUND

Campgrounds typically manage campsite reservations through manual tracking and/or a paper-based reservation system. For example, campgrounds typically designate some campgrounds as either reservable or walk-in only. Further, many campgrounds manage walk-in campsite reservations using a paper-based process in which potential campers search for potentially open campsites (e.g., based on the presence of a tent, camper, or other dwelling structure) and place an envelope with contact information and payment in a fortified metal box often referred to as an “iron ranger.” Campground staff then manage open campsites based on information collected in the iron ranger. In some cases, campground staff place paper notifications on posts to indicate the durations of reservations.

However, such systems suffer from a lack of flexibility, transparency, and/or ease of use. There is therefore a need to develop systems and methods to cure the above deficiencies.

### SUMMARY

In some embodiments, a campsite management system is provided. The campsite management system may include one or more signposts configured to be located in a campground including a plurality of campsites. Each signpost of the one or more signposts may provide a site-specific address associated with a set of one or more campsites of the plurality of campsites. The campsite management system may include a registration controller configured to be communicatively coupled with a communication network. The registration controller may include one or more processors configured to execute program instructions causing the one or more processors to track registration statuses for the plurality of campsites. The registration status for a particular campsite of the plurality of campsites may include at least an available condition indicating that the particular campsite is registrable, an occupied condition indicating that the particular campsite is currently in use, a reserved condition indicating that the particular campsite is unoccupied but has been paid for or has a future reservation, and an unavailable condition indicating that the particular campsite is closed. The one or more processors may receive, from a mobile device of a user via the communication network, a request including the site-specific address of a particular signpost of the one or more signposts. The one or more processors may transmit, to the mobile device via the communication network, the registration statuses of the set of one or more campsites associated with the site-specific address. The one or more processors may update the registration status of at least one campsite of the set of one or more campsites associated with the site-specific address in response to one or more requests received from the mobile device via the communication network.

In some embodiments, a particular signpost may include a display device configured to be communicatively coupled with the communication network.

In some embodiments, the program instructions may further cause the one or more processors of the registration controller to direct the display device to display the registration statuses for the set of one or more campsites associated with the particular signpost.

In some embodiments, the display device may display the site-specific address of the particular signpost.

In some embodiments, updating the registration status may include at least one of registering, checking in to an existing reservation, or checking out.

In some embodiments, the program instructions may further cause the one or more processors of the registration controller to accept payment via the mobile device of the user.

In some embodiments, the registration controller may communicate with the mobile device through an internet portal via the communication network.

In some embodiments, the internet portal may include at least one of a website or an application executable on a mobile device.

In some embodiments, a particular signpost may include a communication system configured to communicate with the registration controller via the communication network.

In some embodiments, the communication system may include a cellular radio.

In some embodiments, the communication network may include a gateway located in the campground. The particular signpost may communicate with the gateway via a first communication channel. The gateway may communicate with the registration controller via a second communication channel.

In some embodiments, the first communication channel may include at least one of a WiFi communication channel, a Long Range (LoRA) communication channel, or a wired communication channel.

In some embodiments, the second communication channel may include a cellular communication channel.

In some embodiments, the campsite management system may further include power monitoring circuitry configured to monitor power consumption at one or more campsites of the plurality of campsites. The power monitoring circuitry may provide power consumption data to the registration controller.

In some embodiments, the campsite management system may further include one or more sensors associated with one or more campsites of the plurality of campsites. The one or more sensors may be configured to detect occupancy of the one or more campsites and provide occupancy data to the registration controller.

In some embodiments, the one or more sensors may include at least one of power monitoring circuitry configured to monitor power consumption, a parking pad sensor configured to detect vehicle presence, a radio-frequency sensor configured to detect radio-frequency signals from electronic devices, a motion sensor, a camera, or a temperature sensor.

In some embodiments, the one or more processors may be further configured to execute program instructions causing the one or more processors to compare the occupancy data with the registration statuses for the plurality of campsites and generate an alert when the occupancy data indicates that a particular campsite is occupied and the registration status for the particular campsite indicates the available condition or the reserved condition with a future check-in date.

In some embodiments, the campsite management system may further include power distribution circuitry at one or more campsites of the plurality of campsites. The one or more processors may be further configured to direct the power distribution circuitry to selectively provide power to a particular campsite when the particular campsite has a registration status of the occupied condition or the reserved condition with a current check-in date.

In some embodiments, the program instructions may further cause the one or more processors of the registration controller to send automated notifications to a registered user associated with a particular campsite. The automated notifications may include at least one of a check-in reminder, a check-out reminder, a reservation extension offer, or a renewal follow-up message.

In some embodiments, the program instructions may further cause the one or more processors of the registration controller to automatically cancel a reservation for a particular campsite when the particular campsite remains unoccupied beyond a grace period following an expected check-in time and update the registration status of the particular campsite from the reserved condition to the available condition.

In some embodiments, the one or more processors may be further configured to execute program instructions causing the one or more processors to monitor a check-in time for a particular campsite having the reserved condition. When the check-in time has passed without check-in completion, the one or more processors may determine whether the particular campsite remains unoccupied. When the particular campsite remains unoccupied beyond a grace period beyond the check-in time, the one or more processors may automatically cancel a reservation for the particular campsite and update the registration status from the reserved condition to the available condition.

In some embodiments, a registration controller for managing campsites in a campground is provided. The registration controller may include one or more processors configured to execute program instructions causing the one or more processors to track registration statuses for a plurality of campsites in the campground. The registration status for a particular campsite of the plurality of campsites may include at least an available condition indicating that the particular campsite is registrable, an occupied condition indicating that the particular campsite is currently in use, a reserved condition indicating that the particular campsite is unoccupied but has been paid for or has a future reservation, and an unavailable condition indicating that the particular campsite is closed. The one or more processors may receive, from a mobile device of a user via a communication network, a request including a site-specific address associated with a set of one or more campsites of the plurality of campsites. The site-specific address may be provided by a signpost located in the campground. The one or more processors may transmit, to the mobile device via the communication network, the registration statuses of the set of one or more campsites associated with the site-specific address. The one or more processors may update the registration status of at least one campsite of the set of one or more campsites associated with the site-specific address in response to one or more requests received from the mobile device via the communication network.

In some embodiments, a registration controller for managing campsites in a campground is provided. The registration controller may include one or more processors configured to execute program instructions causing the one or more processors to monitor occupancy of a plurality of campsites using one or more sensors. The one or more processors may compare occupancy data from the one or more sensors with registration statuses for the plurality of campsites. When the occupancy data indicates that a particular campsite of the plurality of campsites is occupied but not reserved, the one or more processors may generate at least one of a compliance alert or direct power distribution circuitry to disconnect electrical power to the particular campsite.

### BRIEF DESCRIPTION OF FIGURES

The numerous advantages of the disclosure may be better understood by those skilled in the art by reference to the accompanying figures.

FIG. 1A illustrates a block diagram view of an electronic reservation system, in accordance with one or more embodiments of the present disclosure.

FIG. 1B illustrates a block diagram view of the electronic reservation system, in accordance with one or more embodiments of the present disclosure.

FIG. 2 illustrates a block diagram of a signpost, in accordance with one or more embodiments of the present disclosure.

FIG. 3 illustrates a block diagram of the registration controller, in accordance with one or more embodiments of the present disclosure.

FIG. 4A illustrates a block diagram of a first topology of the electronic reservation system, in accordance with one or more embodiments of the present disclosure.

FIG. 4B illustrates a block diagram of a second topology of the electronic reservation system, in accordance with one or more embodiments of the present disclosure.

FIG. 5 illustrates a high-level operational diagram of the electronic reservation system, in accordance with one or more embodiments of the present disclosure.

FIG. 6A illustrates an image of information displayed on a signpost, in accordance with one or more embodiments of the present disclosure.

FIG. 6B illustrates three different non-limiting examples of dynamic images that may be displayed on a display of a signpost.

FIG. 7A illustrates a flow diagram for registering for a campsite, in accordance with one or more embodiments of the present disclosure.

FIG. 7B illustrates a flow diagram for a registration renewal follow-up, in accordance with one or more embodiments of the present disclosure.

FIG. 7C illustrates a flow diagram for unregistering for a campsite, in accordance with one or more embodiments of the present disclosure.

FIG. 8 illustrates a flowchart for method for managing campsites in a campground, in accordance with one or more embodiments of the present disclosure.

FIG. 9 illustrates a flowchart for a method for user interaction with the campsite reservation system using electronic signposts, in accordance with one or more embodiments of the present disclosure.

FIG. 10 illustrates a flowchart for a method for occupancy monitoring in the campsite management system, in accordance with one or more embodiments of the present disclosure.

FIG. 11 illustrates a flowchart for method for automated reservation management, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing an ad-hoc registration of available campsites based on signposts with connectivity to a reservation controller. In some embodiments, the signposts may include a printed sign displaying static information. In some embodiments, the signposts may include a display device with an adjustable display. In some embodiments, signposts may be placed throughout campsites, where the signposts may display various information to campers including, but not limited to, availability status or reservation windows. The signposts may further display links or other information allowing a camper to perform tasks related to associated campsites such as, but not limited to, placing a reservation (e.g., a registration), modifying a reservation, performing a check-in or a check-out of a campsite, or making a payment. For example, the signposts may provide a QR code (either on a printed sign or on a display device) providing a link allowing a camper to perform the tasks using a mobile device.

It is contemplated herein that the systems and methods disclosed herein may provide a flexible and powerful reservation system that is easy to use for both campground managers and campers.

For example, systems and methods disclosed herein may eliminate paper-based management, along with the associated risks and downsides. As an illustration, paper-based systems may have at least the following downsides: they require cash or check, transactions are “on your honor”, they limit accountability to proprietor in the case of damage, they limit communication between campers and proprietors, they allow non-payers to steal services, they provide unreliable campsite availability information, they are manual labor intensive, they limit “off-season” campsite usage, they limit check-in availability during off hours, and/or they discourage new campers.

In contrast, the systems and methods disclosed herein allow a campground to accept walk-in reservations at any time of day or season without the requirement of on-site staff as well as expand payment options to any mobile-based payment. Further, the systems and methods disclosed herein may enable a campground to dynamically control the registration status of each campsite, including whether a particular campsite has an available condition for walk-in reservations, a reserved condition for future or current reservations, an occupied condition when currently in use, or an unavailable condition when closed for maintenance or other reasons, and may provide detailed information about available reservation days/times.

The systems and methods disclosed herein may provide increased transparency regarding available campsites. For example, whereas traditional paper-based management systems require a camper and/or campground staff to physically check the availability of various campsites, the systems and methods disclosed herein may provide up-to-date information to both campers and campground staff regarding the registration status of each campsite, where registration statuses can include, but are not limited to, whether each campsite has an available condition, an occupied condition, a reserved condition, or an unavailable condition.

In some embodiments, the electronic signposts include one or more sensors that may provide information back to the reservation controller such as, but not limited to, occupancy, weather conditions, or site conditions.

The signposts may be provided as standalone devices or may be coupled to power distribution hookups for campsites that provide electricity.

The signposts may be connected to the reservation controller either directly or indirectly via a gateway using any communication protocol or protocols.

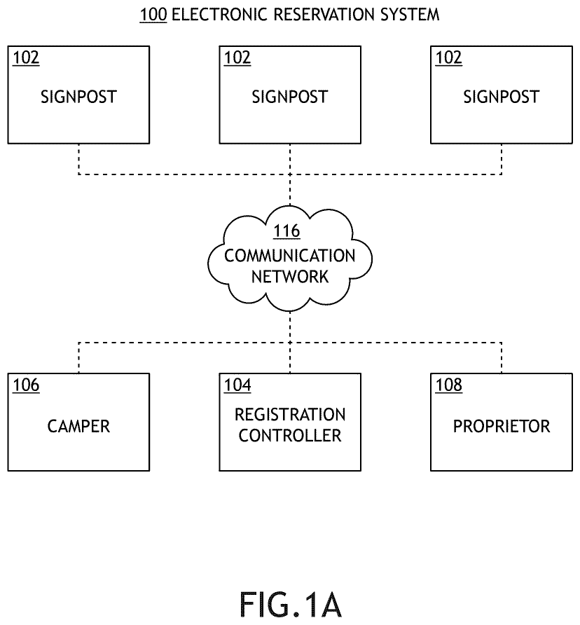

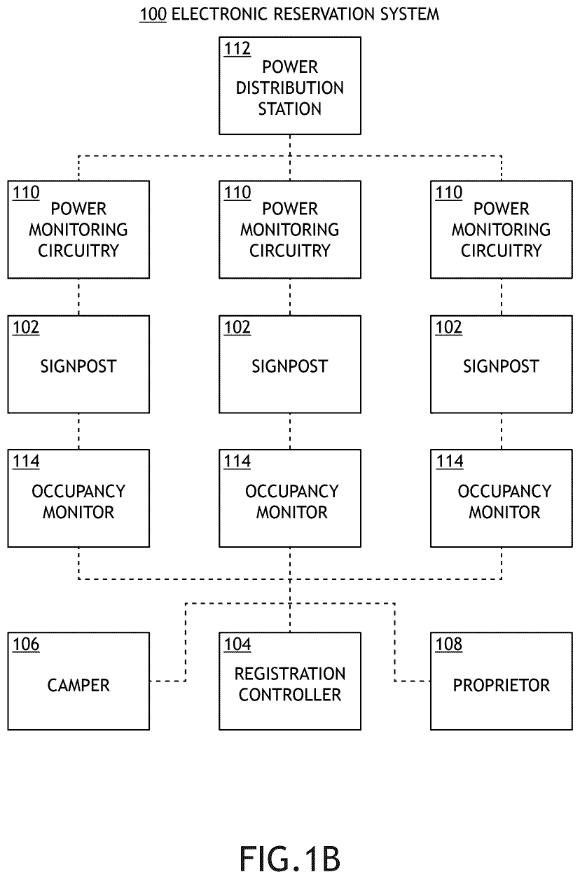

Referring now to FIGS. 1A-11, systems and methods providing campsite reservations are described in greater detail, in accordance with one or more embodiments of the present disclosure.

FIG. 1A illustrates a block diagram view of an electronic reservation system 100, in accordance with one or more embodiments of the present disclosure.

In some embodiments, the electronic reservation system 100 includes one or more signposts 102 configured to be placed at or near campsites, where the one or more signposts 102 may be communicatively coupled with a registration controller 104 via a communication network 116. The signposts 102 may include printed signs, display devices, or a combination thereof. Further, the one or more signposts 102 may be in one-directional or two-directional communication with the registration controller 104 via the communication network 116. For example, in embodiments where the signposts 102 include display devices, the registration controller 104 may direct the one or more signposts 102 to display information via the communication network 116. As another example, the one or more signposts 102 may provide information regarding a campsite to the registration controller 104 via the communication network 116.

As used herein, the term “communication network” refers to any network or combination of networks that enables communication between components of the electronic reservation system. The communication network 116 may include, but is not limited to, the internet, cellular networks, WiFi networks, local area networks, wide area networks, or any combination thereof. The communication network 116 may utilize wired or wireless communication protocols and may include intermediate devices such as gateways, routers, or access points that facilitate communication between system components.

Users such as, but not limited to, a camper 106 or a proprietor 108 (e.g., campground staff) may interact with the electronic reservation system 100 via the one or more signposts 102 and/or the registration controller 104 (e.g., through an internet interface).

In some embodiments, each signpost 102 provides a site-specific address that is associated with one or more campsites. The site-specific address may include any identifier or combination of identifiers suitable for enabling a user to interact with the electronic reservation system 100 via a mobile device. For example, a site-specific address may include a QR code, a URL, a Bluetooth Low Energy (BLE) identifier, a near-field communication (NFC) tag, a site number, or any other machine-readable or human-readable identifier. The site-specific address may be displayed on a printed sign, on a display device, or a combination thereof.

In some embodiments, a signpost 102 may be dedicated to a single campsite, where the site-specific address provided by the signpost 102 is associated with that single campsite. In such embodiments, when a user scans or otherwise accesses the site-specific address with their mobile device, the mobile device may send a request including the site-specific address to the registration controller 104 via the communication network 116. The registration controller 104 may receive the request including the site-specific address and may identify the specific campsite associated with that site-specific address. The registration controller 104 may then transmit, to the mobile device via the communication network 116, the registration status of the campsite associated with the site-specific address. For example, the registration controller 104 may transmit information indicating whether the campsite has an available condition, an occupied condition, a reserved condition, or an unavailable condition. The user may then view the registration status on their mobile device and, if the campsite has an available condition, may proceed to create a reservation for that campsite. The user may update the registration status of the campsite by sending one or more requests from the mobile device to the registration controller 104 via the communication network 116. For example, the user may submit a reservation request, provide payment information, and complete a registration process, all through interactions with the mobile device. Upon receiving these requests, the registration controller 104 may update the registration status of the campsite from the available condition to the reserved condition or the occupied condition, depending on the timing of the reservation. This approach may provide a fast and easy technique for campsite management, allowing a user who is physically present at a campsite to quickly identify that specific campsite, view its current registration status, and create and pay for a reservation without requiring the user to navigate complex menus or search for the specific campsite within a broader system interface.

In some embodiments, a signpost 102 may be associated with a group of campsites, such as a loop of campsites or a cluster of campsites in a particular area of the campground. In such embodiments, the site-specific address provided by the signpost 102 is associated with the set of multiple campsites in the group. When a user scans or otherwise accesses the site-specific address with their mobile device, the mobile device may send a request including the site-specific address to the registration controller 104 via the communication network 116. The registration controller 104 may receive the request including the site-specific address and may identify the group of campsites associated with that site-specific address. The registration controller 104 may then transmit, to the mobile device via the communication network 116, the registration statuses of all campsites in the set associated with the site-specific address. For example, the registration controller 104 may transmit a list or map showing which campsites in the group have an available condition, which have an occupied condition, which have a reserved condition, and which have an unavailable condition. The user may then view the registration statuses of all campsites in the group on their mobile device and may select one or more available campsites from the group for reservation. The user may update the registration status of one or more campsites in the group by sending one or more requests from the mobile device to the registration controller 104 via the communication network 116. For example, the user may select a specific campsite from the group, submit a reservation request for that campsite, provide payment information, and complete a registration process. Upon receiving these requests, the registration controller 104 may update the registration status of the selected campsite from the available condition to the reserved condition or the occupied condition. This group signpost approach may be particularly useful in campgrounds where campsites are organized in loops or clusters, allowing users to view availability for an entire area and select their preferred campsite from among the available options without requiring individual signposts at each campsite.

The use of site-specific addresses on signposts 102 may provide several advantages for campsite management. The site-specific addresses may enable direct and immediate access to campsite-specific information without requiring users to navigate through multiple levels of menus or search interfaces. When a user scans a QR code or otherwise accesses a site-specific address, they may be immediately presented with relevant information about the associated campsite or group of campsites, streamlining the reservation process. The site-specific addresses may also reduce errors in campsite identification, as the user is directly interacting with the signpost at or near the campsite they wish to reserve, eliminating potential confusion about campsite numbers or locations. Furthermore, the site-specific addresses may enable the electronic reservation system 100 to track which signposts are being accessed and when, providing valuable data to proprietors 108 about user behavior and campsite popularity.

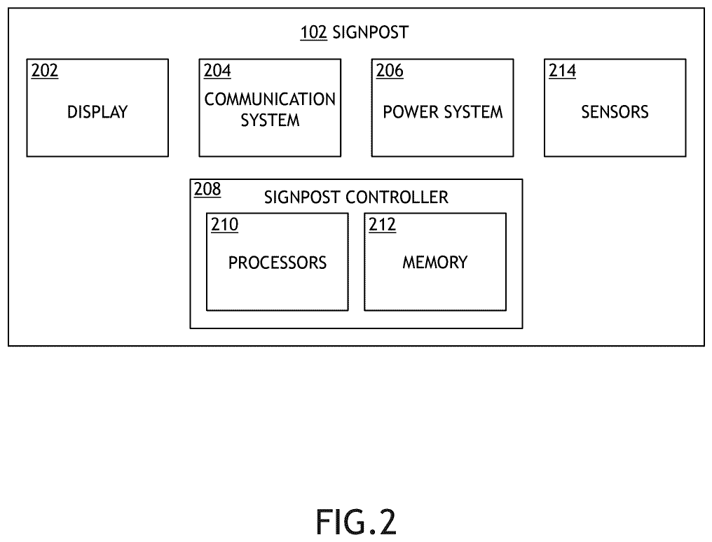

FIG. 2 illustrates a block diagram of a signpost 102, in accordance with one or more embodiments of the present disclosure.

In some embodiments, a signpost 102 includes a display 202 to display various information. The display 202 may include any component or combination of components suitable for providing visual information such as, but not limited to, an electronic ink display, a liquid crystal device (LCD), a light emitting diode (LED) display, or an organic LED (OLED) display. In some embodiments, a signpost 102 may include a printed sign instead of or in addition to a display 202, where the printed sign may display static information such as, but not limited to, instructions, site identifiers, or QR codes.

In some embodiments, a signpost 102 includes a communication system 204 suitable for communicating with the registration controller 104 directly or indirectly through a gateway. The communication system 204 may provide communication via any combination of wireless or wired protocols such as, but not limited to, cellular, WiFi, Bluetooth, Bluetooth Low Energy (BLE), radio frequency (RF), or LoRa (long range) radio. Accordingly, the communication system 204 may include any components or combinations of components suitable for providing communication through a desired protocol including, but not limited to, an antenna, receiver, transceiver, modulator, demodulator, or the like. In some embodiments, a signpost 102 with a printed sign may include a communication system 204 to enable data transmission to the registration controller 104, such as sensor data or status information.

In some embodiments, a signpost 102 includes or connects to a power system 206. The power system 206 may provide power to a campsite and/or receive power from any source. For example, a power system 206 may receive wired power from a power distribution hookup providing electricity to a campsite or solely to the signpost 102. As another example, a power system 206 may receive power from solar panels. As another example, a power system 206 may receive power from one or more batteries. Accordingly, the power system 206 may include any components or combination of components suitable for providing or receiving power including, but not limited to, solar panels, batteries, alternating current (AC) to direct current (DC) converters, AC/AC converters, DC/DC converters, or the like.

In some embodiments, a signpost 102 includes a signpost controller 208 with one or more processors 210 configured to execute program instructions on memory 212 (e.g., a memory device). The processors 210 may include any type of processing device known in the art including, but not limited to, a microprocessor, a microcontroller, a field-programmable gate array (FPGA), an application-specific integrated circuit (ASIC), a digital signal processor (DSP), a central processing unit (CPU), or a graphical processing unit (GPU). The memory 212 may include any storage device (e.g., a non-transitory medium) including, but not limited to, a read-only memory, a random-access memory, a solid-state drive, or the like.

The processors 210 of the signpost controller 208 may execute program instructions causing the processors 210 to implement any of the various steps disclosed herein. For example, in embodiments where the signpost 102 includes a display 202, the program instructions may cause the processors 210 to direct at least a portion of the signpost to display (e.g., on the associated display 202) information (e.g., text, images, or the like) in response to communication signals received from the communication system 204. In embodiments where the signpost 102 includes a printed sign, the program instructions may cause the processors 210 to manage sensor data collection and communication with the registration controller 104.

In some embodiments, a signpost 102 includes one or more sensors 214. The signpost 102 may include any type of sensors 214 known in the art such as, but not limited to, occupancy sensors, motion sensors, temperature sensors, humidity sensors, precipitation sensors, cameras, or microphones. The sensors 214 may provide any type of information about the campsite including, but not limited to, occupancy status, weather conditions, or the presence of wildlife.

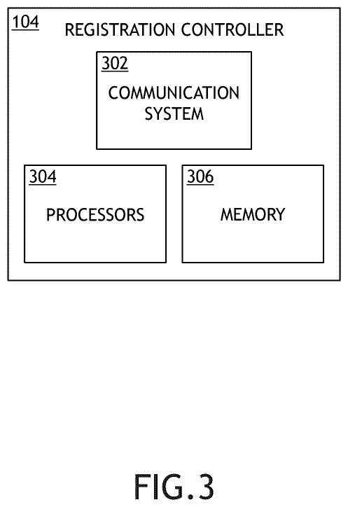

FIG. 3 illustrates a block diagram of the registration controller 104, in accordance with one or more embodiments of the present disclosure.

In some embodiments, the registration controller 104 includes communication system 302 suitable for communicating with the signposts 102 directly or indirectly through a gateway. The communication system 302 may be similar to the communication system 204 such that the description of the communication system 204 may apply to the communication system 302.

In some embodiments, the registration controller 104 includes one or more processors 304 coupled to a memory 306. The description of the processors 210 and the memory 212 may be similar to the processors 304 and the memory 306 such that the descriptions of the processors 210 and the memory 212 may extend to the processors 304 and the memory 306. The registration controller 104 may thus implement various steps described throughout the present disclosure. For example, the registration controller 104 may track a registration status for each of the plurality of campsites, where the registration status for a particular campsite of the plurality of campsites includes at least an available condition indicating that the particular campsite is registrable, an occupied condition indicating that the particular campsite is currently in use, a reserved condition indicating that the particular campsite is unoccupied but has been paid for or has a future reservation, and an unavailable condition indicating that the particular campsite is closed such as for maintenance. As another example, in embodiments where the signposts include display devices, the registration controller 104 may direct the plurality of signposts to display information indicative of the registration status for the plurality of campsites on the display devices.

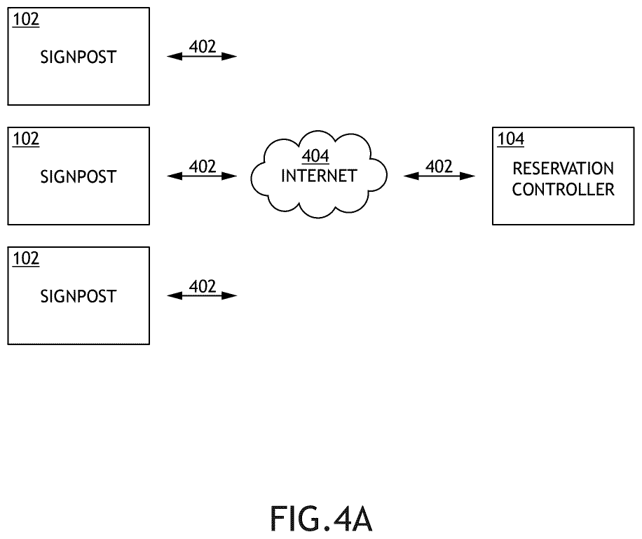

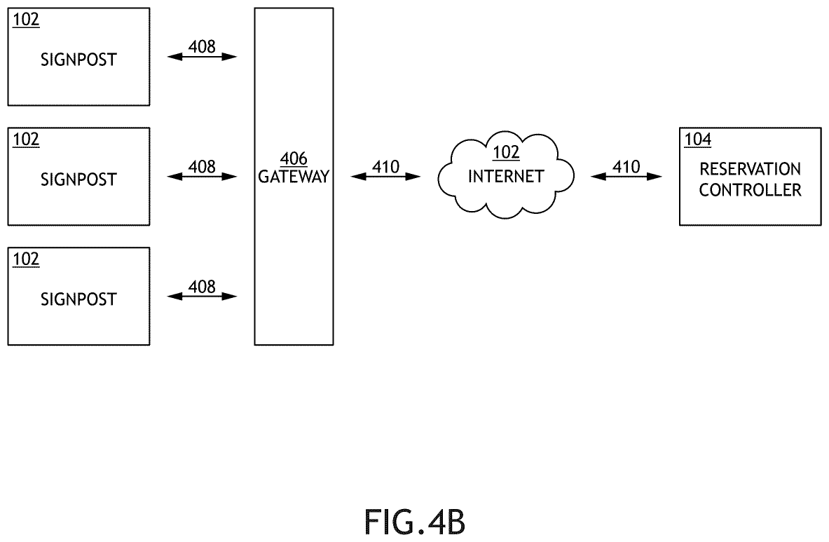

Referring now to FIGS. 4A-4B, communication pathways between the signposts 102 and the registration controller 104 are described in greater detail, in accordance with one or more embodiments of the present disclosure.

FIG. 4A illustrates a block diagram of a first topology of the electronic reservation system 100, in accordance with one or more embodiments of the present disclosure. In FIG. 4A, the signposts 102 communicate via communication channels 402 with the registration controller 104 via the internet 404. The internet 404 may form part of the communication network 116 that enables communication between the signposts 102 and the registration controller 104. Any type of communication channels 402 may be used including, but not limited to cellular channels.

FIG. 4B illustrates a block diagram of a second topology of the electronic reservation system 100, in accordance with one or more embodiments of the present disclosure. In FIG. 4B, the signposts 102 communicate with a gateway 406 via communication channels 408 and the gateway 406 communicates with the registration controller 104 via communication channels 410. The gateway 406 and the communication channels 408 and 410 may form part of the communication network 116 that enables communication between the signposts 102 and the registration controller 104. It is contemplated that the topology in FIG. 4B may be extended to any combination of communication channels 408 and communication channels 410. In some embodiments, the gateway 406 is located within a campground such that the communication channels 408 may utilize relatively short-distance protocols such as, but not limited to, wired protocols, WiFi, LoRa, or the like. The gateway 406 may then connect to the internet 404 and ultimately to the registration controller 104 via any technique. In this way, the gateway 406 may have communications circuitry and an associated controller similar to that described with respect to the electronic signpost 102 or the registration controller 104.

Referring now to FIG. 1B, additional aspects of the electronic reservation system 100 are described in greater detail, in accordance with one or more embodiments of the present disclosure. FIG. 1B illustrates a block diagram view of the electronic reservation system, in accordance with one or more embodiments of the present disclosure.

In some embodiments, the electronic reservation system 100 implements power monitoring, which may be utilized for any purpose including, but not limited to, monitoring occupancy of campsites that include power hookups. It is contemplated herein that occupancy detection typically requires either human interaction (e.g., in the form of a campsite manager visiting each campsite) or the use of sensors that may be prone to failure, false readings, or have relatively high cost. For example, imaging sensors operating in visible or infrared wavelengths may be used to determine occupancy, but may provide privacy concerns for campers and/or may be prone to false readings based on animal movement or other factors. However, active use of power from a campsite power distribution hookup may provide a reliable indication of occupancy of a campsite.

In some embodiments, the electronic reservation system 100 includes power monitoring circuitry 110 that may connect directly to power distribution hookups at campsites. The power monitoring circuitry 110 may be located either at the campsites themselves or at a central power distribution station 112 as illustrated in FIG. 1B. In the case where the power monitoring circuitry 110 is located at the campsite, it may optionally be integrated with a signpost 102 as a communications device. The power monitoring circuitry 110 may include any type of active or passive components suitable for determining whether power is being drawn from a power distribution hookup and optionally how much power is being drawn. Further, the power monitoring circuitry 110 may include or correspond to a sensor 214 as shown in FIG. 2.

In some embodiments, the power monitoring circuitry 110 may establish a baseline power consumption threshold to distinguish between occupied and vacant conditions. For example, the power monitoring circuitry 110 may detect power draw above a predetermined threshold (e.g., 100 watts, 500 watts, or any suitable value) as an indication of active occupancy. In some embodiments, the power monitoring circuitry 110 may analyze patterns of power usage over time to determine occupancy status. For example, continuous power draw over an extended period may indicate occupancy, while intermittent or minimal power draw may indicate vacancy. The power monitoring circuitry 110 may perform continuous monitoring of power consumption or may utilize periodic sampling at regular intervals (e.g., every minute, every five minutes, every hour, or any suitable interval) to determine occupancy status while reducing power consumption and data transmission requirements.

In some embodiments, the electronic reservation system 100 may include power distribution circuitry configured to selectively control the provision of electrical power to one or more campsites based on registration status or other criteria. The power distribution circuitry may enable automated enforcement of reservation policies by controlling access to electrical services at campsites. For example, the power distribution circuitry may provide electrical power to a campsite when the campsite has a registration status of the occupied condition or the reserved condition with a current check-in date, indicating that the campsite has been paid for and is authorized for use. As another example, the power distribution circuitry may disconnect or disable electrical power to a campsite when the campsite is occupied but has a registration status of the available condition, indicating unauthorized use without payment. The power distribution circuitry may also disable electrical power when a reservation has expired or when a campsite transitions to the unavailable condition for maintenance or other reasons.

The power distribution circuitry may include any type of power control electronics suitable for controlling the flow of electrical power to campsites. For example, the power distribution circuitry may include, but is not limited to, relays, solid-state relays, circuit breakers with remote control capabilities, smart switches, or other electronically controllable switching devices. In some embodiments, the relays may be configured as normally open relays that close to provide power when energized, or as normally closed relays that open to disconnect power when energized, where the selection between normally open and normally closed configurations may depend on desired fail-safe behavior and power management requirements. The power distribution circuitry may be configured to receive control signals from the registration controller 104 via the communication network 116, where the control signals direct the power distribution circuitry to enable or disable power to specific campsites based on registration status, occupancy data, payment status, or other criteria.

In some embodiments, the power distribution circuitry may be provided as a standalone component of the electronic reservation system 100, separate from other system components. For example, the power distribution circuitry may be housed in a dedicated enclosure located at or near a campsite, or may be centrally located at the central power distribution station 112 with individual control channels for each campsite. In some embodiments, the power distribution circuitry may be integrated into the power distribution hookup at a campsite, providing a compact solution that combines power delivery and power control functionality in a single unit. In some embodiments, the power distribution circuitry may be integrated with a signpost 102, allowing the signpost 102 to directly control power delivery to the associated campsite based on commands received from the registration controller 104.

Occupancy detection is now described in greater detail, in accordance with one or more embodiments of the present disclosure. In some embodiments, the electronic reservation system 100 may include any type or combination of sensors 214 suitable for detecting occupancy.

In some embodiments, the electronic reservation system 100 may utilize parking pad occupation detection as a technique for monitoring occupancy of campsites. The electronic reservation system 100 may include one or more parking pad sensors configured to detect the presence of a vehicle at a campsite. The parking pad sensors may include any type of sensor suitable for detecting vehicle presence including, but not limited to, pressure sensors, magnetic sensors, optical sensors, ultrasonic sensors, or cameras with vehicle detection capabilities.

In some embodiments, pressure sensors may be embedded in or placed beneath a parking pad surface to detect the weight of a vehicle. The pressure sensors may generate a signal when a vehicle is parked on the parking pad, indicating occupancy of the campsite. In some embodiments, magnetic sensors may detect changes in the local magnetic field caused by the presence of a vehicle. For example, magnetometers or inductive loop sensors may be installed in or near the parking pad to detect the ferromagnetic materials present in vehicles.

In some embodiments, optical sensors may utilize light-based detection techniques to determine vehicle presence. For example, photoelectric sensors, infrared sensors, or laser-based sensors may detect the interruption of a light beam or the reflection of light from a vehicle surface. In some embodiments, ultrasonic sensors may emit ultrasonic waves and detect reflections from objects within a detection zone, allowing determination of whether a vehicle is present on the parking pad.

In some embodiments, cameras with vehicle detection capabilities may be positioned to monitor parking pads. The cameras may utilize image processing algorithms, computer vision techniques, or machine learning models to identify the presence of vehicles in captured images or video streams. The parking pad sensors may be integrated with a signpost 102 to provide communication capabilities for transmitting occupancy data to the registration controller 104. Alternatively, the parking pad sensors may be provided as standalone sensors with dedicated communication systems for transmitting occupancy data.

In some embodiments, the electronic reservation system 100 may utilize radio-frequency (RF) activity detection as a technique for monitoring occupancy of campsites. The electronic reservation system 100 may include one or more RF sensors configured to detect radio-frequency presence signals emitted by electronic devices commonly carried or used by campers. The detection of RF activity may provide an indication of human presence at a campsite without requiring physical contact or visual monitoring.

In some embodiments, the RF sensors may detect WiFi signals transmitted by camper devices such as smartphones, tablets, laptops, or other WiFi-enabled devices. The RF sensors may monitor WiFi channels for the presence of WiFi beacons, probe requests, or data transmissions that indicate active WiFi devices within the vicinity of a campsite. The detection of WiFi signals may indicate that electronic devices, and by extension campers, are present at the campsite.

In some embodiments, the RF sensors may detect Bluetooth or Bluetooth Low Energy (BLE) signals transmitted by mobile devices, wearable devices, or other Bluetooth-enabled equipment. Bluetooth and BLE devices typically transmit periodic advertisement packets that may be detected by appropriately configured receivers. The presence of Bluetooth or BLE signals within the detection range of an RF sensor may indicate occupancy of the associated campsite.

In some embodiments, the RF sensors may detect cellular signals transmitted by mobile phones or other cellular-enabled devices. The RF sensors may monitor cellular frequency bands for the presence of cellular transmissions, which may indicate that campers with mobile phones are present at the campsite.

In some embodiments, the RF sensors may implement privacy-preserving detection approaches that detect the presence of RF signals without identifying specific devices or individuals. For example, the RF sensors may detect the presence of RF activity without capturing, storing, or transmitting device identifiers such as MAC addresses, phone numbers, or other personally identifiable information. The RF sensors may simply determine whether RF activity is present or absent, or may quantify the level of RF activity, without associating the detected signals with specific individuals. This approach may provide occupancy information while respecting camper privacy concerns.

The RF sensors may be integrated with a signpost 102 or may be provided as separate components in communication with the registration controller 104. The RF sensors may continuously monitor for RF activity or may perform periodic scans at regular intervals to detect the presence of RF signals while managing power consumption.

The electronic reservation system 100 may include an occupancy monitor 114 to receive data from any combination of sensors 214 including, but not limited to, the power monitoring circuitry 110, parking pad sensors, or RF sensors associated with the various campsites to determine an occupancy status associated with each campsite. The occupancy monitor 114 may aggregate data from multiple sensor types to provide a more reliable determination of occupancy status. For example, the occupancy monitor 114 may determine that a campsite is occupied when any one of the following conditions is met: power draw exceeds a threshold, a vehicle is detected on the parking pad, or RF activity is detected. Alternatively, the occupancy monitor 114 may require multiple indicators to be present before determining that a campsite is occupied, thereby reducing false positive detections.

The occupancy monitor 114 may be in communication with the registration controller 104 to provide occupancy information to the registration controller 104. The registration controller 104 may compare the occupancy information with registration data to determine compliance or non-compliance with reservation policies. The registration data may include information about which campsites have active reservations, the identities of registered campers, the duration of reservations, and the expected check-in and check-out times.

In some embodiments, the registration controller 104 may identify various compliance scenarios based on the comparison of occupancy information with registration data. For example, a campsite may be determined to be in compliance when the campsite is occupied and has a valid active reservation with a registration status of the occupied condition. As another example, a campsite may be determined to be in non-compliance when the campsite is occupied but has a registration status of the available condition or the reserved condition with a future check-in date, indicating potential unauthorized use. As another example, a campsite may be determined to be in non-compliance when the campsite is vacant despite having a registration status of the occupied condition, which may indicate that a camper has not yet arrived for a confirmed reservation or has departed early without checking out. As another example, a campsite with a registration status of the reserved condition may transition to the occupied condition when occupancy is detected at or after the expected check-in time.

In some embodiments, the registration controller 104 may trigger alerts or notifications based on compliance or non-compliance determinations. For example, when a campsite is determined to be occupied without a valid reservation, the registration controller 104 may send an alert to a proprietor 108 (e.g., campground staff) to investigate the situation. The alert may include information such as the campsite identifier, the time the unauthorized occupancy was detected, and any available sensor data. As another example, when a campsite with an active reservation is determined to be occupied, the registration controller 104 may send an automated message to the registered camper 106 prompting them to complete a check-in process if check-in has not yet been performed.

In some embodiments, the registration controller 104 may implement grace periods before triggering alerts or taking automated actions. For example, when a campsite with an active reservation is detected as vacant after the expected check-in time, the registration controller 104 may wait for a grace period (e.g., one hour, two hours, or any suitable duration) before sending an alert to the camper 106 or the proprietor 108. This grace period may accommodate situations where campers are delayed in arriving or are temporarily away from the campsite.

In some embodiments, the registration controller 104 may take various automated actions based on compliance determinations. For example, the registration controller 104 may automatically cancel a reservation if a campsite remains vacant beyond a specified time after the expected check-in time and any applicable grace period. As another example, the registration controller 104 may automatically extend a reservation if a campsite remains occupied beyond the scheduled check-out time and the campsite has no subsequent reservations, subject to campground policies and payment processing. In some embodiments, the registration controller 104 may implement enforcement actions for non-compliance situations, such as when a campsite is occupied without a valid reservation. These enforcement actions may include activating a visual signal on the associated signpost 102 (in embodiments with display devices) to indicate unauthorized occupancy, disabling electrical power to the campsite through the power monitoring circuitry 110 to discourage continued unauthorized use, and/or automatically notifying campground staff through alerts sent to the proprietor 108 to enable prompt intervention. The registration controller 104 may send notifications to campers 106 and proprietors 108 regarding any automated actions taken, ensuring transparency in the management of campsite reservations.

It is to be understood that the configuration depicted in FIG. 1B is merely illustrative and should not be interpreted as limiting. Any components of the electronic reservation system 100 may include communication circuitry suitable for communicating with the registration controller 104. In some embodiments, components may separately communicate with the registration controller 104, where each component includes dedicated communication circuitry for independent data transmission. In some embodiments, any of the components may share communication circuitry, allowing multiple components to utilize common communication hardware for transmitting data to the registration controller 104. In some embodiments, components may share housings, where multiple functional elements are integrated within a single physical enclosure. For example, the power monitoring circuitry 110, sensors 214, and communication circuitry may be housed together in a single unit, or may be distributed across separate housings depending on installation requirements and campground infrastructure. The occupancy monitor 114 may be implemented as a standalone component, may be integrated within the registration controller 104, or may be distributed across multiple devices within the electronic reservation system 100.

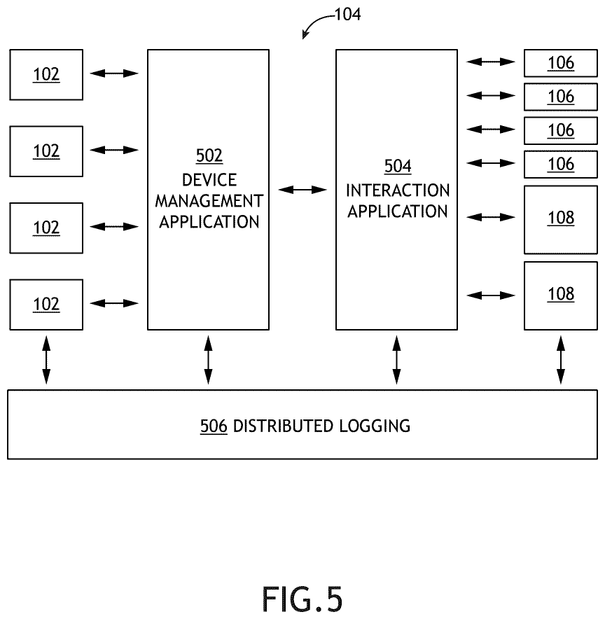

FIG. 5 illustrates a high-level operational diagram of the electronic reservation system 100, in accordance with one or more embodiments of the present disclosure.

In FIG. 5, multiple signposts are connected to a device management application 502, which may be hosted and/or executed on the registration controller 104 and/or a gateway 406. For example, in embodiments where the signposts 102 include display devices, the device management application 502 may direct the signposts 102 to display information associated with the respective campsites on the associated displays 202.

Various users including campers 106 and proprietors 108 may interact with an interaction application 504, which may provide an interface for functions such as, but not limited to, viewing campsite availability, managing reservations (e.g., making, modifying, and/or cancelling reservations), payments, or the like. The interaction application 504 may be hosted and/or executed in any way. In some embodiments, the interaction application 504 is provided as an internet application (e.g., a web app, a website, an internet portal, or the like) that may be accessed through any browser. In some embodiments, the interaction application 504 is provided as a mobile application that may be installed on mobile devices (e.g., mobile phones, tablets, or the like). Accordingly, the interaction application 504 may be executed and/or hosted on any combination of the registration controller 104 or user-provided devices. The interaction application 504 may communicate with the registration controller 104 via the communication network 116.

In some embodiments, the electronic reservation system 100 provides a distributed logging system 506 that creates and/or captures logs associated with any component of the electronic reservation system 100. The distributed logging system 506 may be hosted on any component including, but not limited to, the registration controller 104.

In some embodiments, the electronic reservation system 100 may maintain logs of various system events and activities. The distributed logging system 506 may record presence detections captured by any combination of sensors including power monitoring circuitry 110, parking pad sensors, or RF sensors, creating a timestamped record of when occupancy was detected or when a campsite became vacant. The system may log enforcement actions taken by the registration controller 104, such as alerts sent to proprietors 108, visual signals activated on signposts 102, or power disabling actions initiated through power monitoring circuitry 110. Communication events may be logged, including messages exchanged between campers 106 and proprietors 108, automated notifications sent by the system, and interactions with the interaction application 504. Power usage data from the power monitoring circuitry 110 may be continuously logged to track consumption patterns over time. Check-in and check-out events may be recorded, capturing when campers 106 complete these processes through the interaction application 504 or when the system automatically processes these events based on occupancy detection and reservation schedules.

In some embodiments, the logged data may be analyzed and processed to generate various types of reports and records. The system may generate occupancy history reports that show patterns of campsite usage over time, including peak occupancy periods, average stay durations, and seasonal trends. Compliance records may be produced that document instances of authorized and unauthorized campsite use, late check-outs, early departures, and adherence to reservation policies. The system may generate operational alerts based on logged data, such as notifications when unusual patterns are detected, when maintenance may be required based on usage levels, or when sensor malfunctions are suspected based on inconsistent readings. Management reports may be generated that provide proprietors 108 with insights into campground performance, including revenue metrics, reservation conversion rates, cancellation patterns, and resource utilization statistics. These reports may be generated on demand or according to scheduled intervals, and may be customized to focus on specific campsites, time periods, or metrics of interest to campground management.

In some embodiments, the electronic reservation system 100 may include an integrated communication system that provides a dedicated phone line for the campground. The integrated communication system may enable bidirectional communication between campers and the campground through multiple channels including text messaging, voice messaging, and email. The phone line may be configured to send automated text messages containing campground information such as facility hours, amenities, rules, emergency procedures, or weather alerts. Additionally, the phone line may send site-specific information such as parking instructions, utility hookup details, checkout procedures, or nearby points of interest. The integrated communication system may receive voice messages from campers, which may be automatically transcribed and surfaced within the registration controller 104 for review by proprietors 108. This voice messaging capability may allow campers to report issues, request assistance, or provide feedback without requiring real-time staff availability.

In some embodiments, the electronic reservation system 100 may provide notification capabilities through SMS or email channels to various categories of users. Currently registered campers may receive notifications regarding their active reservations, including check-in reminders, checkout reminders, reservation extensions, payment confirmations, or urgent campground announcements. Future registrants with upcoming reservations may receive pre-arrival information such as directions, preparation tips, weather forecasts, or policy reminders. Past registrants who have previously stayed at the campground may receive promotional offers, seasonal updates, loyalty program information, or invitations to return. The notification system may be configured to respect user preferences regarding communication frequency and channel selection, allowing campers to opt in or out of various notification types.

In some embodiments, the electronic reservation system 100 may maintain communication threads that associate all interactions with relevant system entities. Communication threads may be linked to user accounts, allowing the registration controller 104 to display a complete communication history for each camper across all their interactions with the campground. Communication threads may also be associated with specific campsite registrations, enabling proprietors 108 to view all messages, inquiries, and responses related to a particular stay. Additionally, communication threads may be tied to campsite history, providing a comprehensive record of all communications associated with a specific campsite over time. This threaded approach may provide full communication visibility, allowing both campers 106 and proprietors 108 to reference previous conversations, track issue resolution, and maintain continuity across multiple interactions. The communication history may be searchable and filterable, enabling efficient retrieval of specific information when needed.

In some embodiments, the electronic reservation system 100 may support mass messaging capabilities that allow proprietors 108 to send communications to multiple recipients simultaneously. The mass messaging feature may enable campground staff to broadcast important announcements to all currently registered campers, such as emergency alerts, facility closures, event notifications, or policy updates. The system may also support targeted messaging to selected groups based on criteria such as campsite location, reservation dates, user demographics, or registration status. For example, proprietors 108 may send weather warnings only to campers in affected areas, or may send activity announcements only to campers staying during specific dates. The mass messaging system may track delivery status and read receipts where available, providing confirmation that important messages have been received by intended recipients.

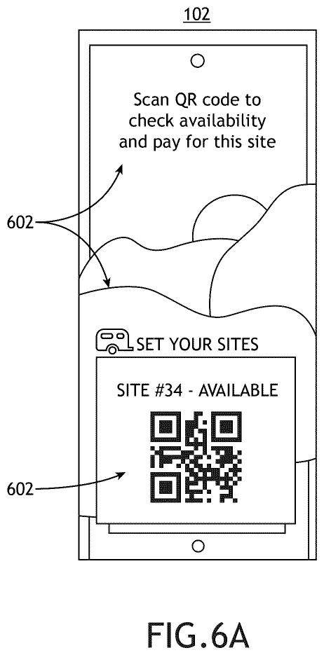

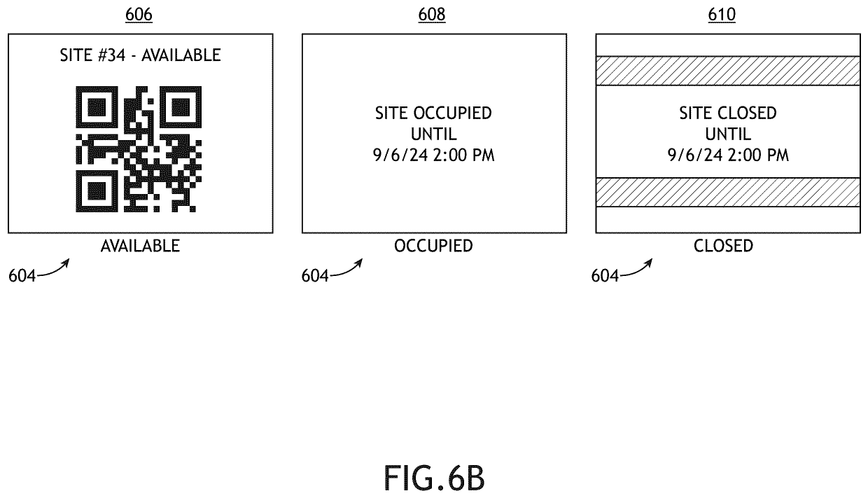

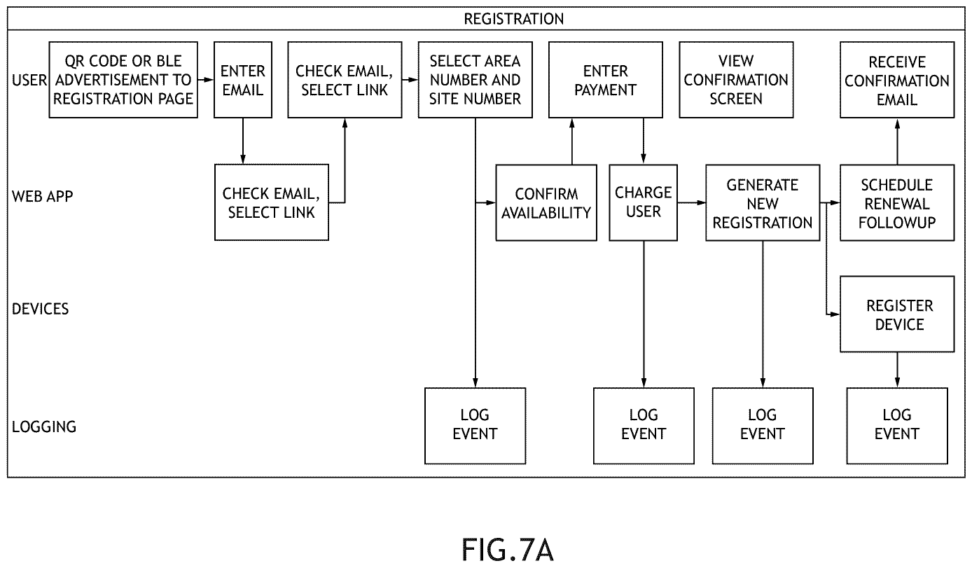

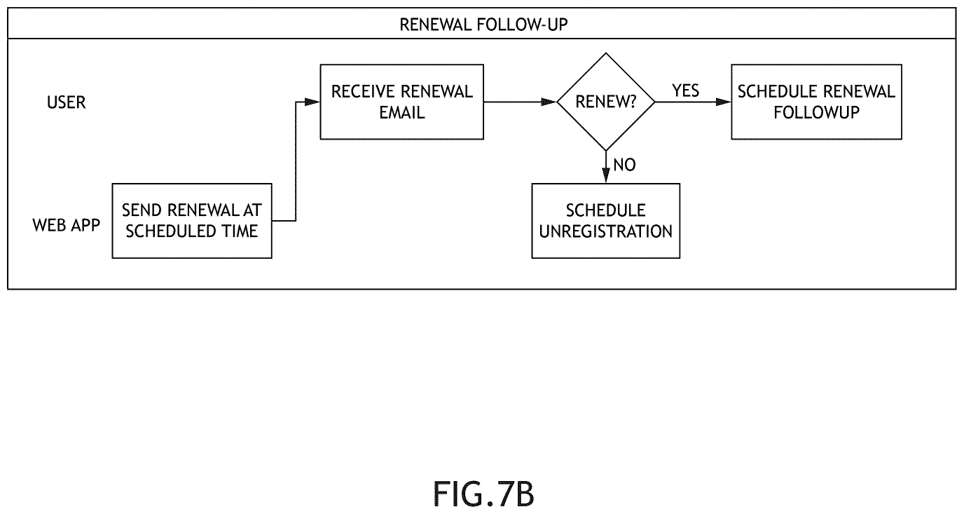

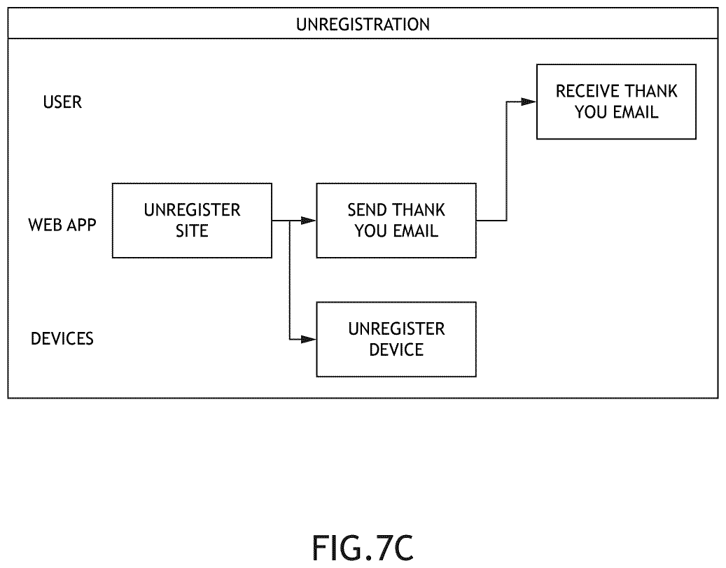

Referring now to FIGS. 6A-7C, the operation of the electronic reservation system 100 are described in greater detail, in accordance with one or more embodiments of the present disclosure.

FIG. 6A illustrates an image of information displayed on a signpost 102, in accordance with one or more embodiments of the present disclosure. A signpost 102 may provide any combination of static images 602 and dynamic images 604 (e.g., programmable images). In some embodiments, the static images 602 may be provided on a printed sign. In some embodiments, the dynamic images 604 may be provided on a display 202. For example, FIG. 6A depicts a configuration with static images 602 with instructions to “Scan QR code to check availability and pay for this site” along with dynamic images 604 including information that the site (Site #34) is available and a QR code that is scannable by a mobile device and provides a link to an interaction application 504 or data for an interaction application 504.

FIG. 6B illustrates three different non-limiting examples of dynamic images 604 that may be displayed on a display 202 of a signpost 102.

Panel 606 is a reproduction of the dynamic images 604 from FIG. 6A including the indication of site availability and the QR code. Such a dynamic image 604 may be suitable for, but is not limited to, times when a campsite associated with the signpost 102 has a registration status of the available condition. In embodiments with a printed sign, similar information including a QR code and site identifier may be statically printed on the sign. Accordingly, a camper 106 may scan the QR code and use the interaction application 504 to take various actions including, but not limited to, reserving the site for a selected number of nights, providing payment, or modifying the reservation.

Panel 608 includes a dynamic image 604 indicating that the site is occupied and provides a duration of the current reservation (here, until Sep. 6, 2024 at 2:00 PM). Such a dynamic image may be suitable for times when the campsite has a registration status of the occupied condition or the reserved condition. In embodiments with a display device, this information may be dynamically updated based on registration status.

Panel 610 includes a dynamic image indicating that the site is closed and provides a duration of the closure (here, until Sep. 6, 2024 at 2:00 PM). Such a dynamic image may be suitable for times when the campsite has a registration status of the unavailable condition, such as when the campground manager desires to make the campsite unreservable for any reason (e.g., site maintenance, or the like). In embodiments with a display device, this information may be dynamically updated.

It is to be understood that FIGS. 6A-6B and the associated descriptions are merely illustrative and should not be interpreted as limiting the scope of the present disclosure. Rather, a signpost 102 may provide information through a printed sign, a display 202, or a combination thereof. In embodiments with a display 202, the signpost 102 may provide any dynamic image 604 with any combination of information. In embodiments with a printed sign, the signpost 102 may provide static information including, but not limited to, site identifiers, QR codes, instructions, or other information enabling campers 106 to interact with the electronic reservation system 100 via mobile devices. In this way, a signpost 102 as disclosed herein may provide a flexible way to communicate information to campers 106 and/or allow campers 106 to interact with the electronic reservation system 100 to accomplish any task.

FIGS. 7A-7C depict various non-limiting operational flows, in accordance with one or more embodiments of the present disclosure.

FIG. 7A illustrates a flow diagram for registering for a campsite, in accordance with one or more embodiments of the present disclosure. In particular, FIG. 7A depicts various process steps performed by a user (e.g., a camper 106), a web app (e.g., an interaction application 504), devices (e.g., an electronic signpost 102), and logging (e.g., associated with distributed logging system 506).

FIG. 7B illustrates a flow diagram for a registration renewal follow-up, in accordance with one or more embodiments of the present disclosure. In particular, FIG. 7B depicts various process steps performed by a user (e.g., a camper 106) and a web app (e.g., an interaction application 504).

FIG. 7C illustrates a flow diagram for unregistering for a campsite, in accordance with one or more embodiments of the present disclosure. In particular, FIG. 7C depicts various process steps performed by a user (e.g., a camper 106), a web app (e.g., an interaction application 504), devices (e.g., an electronic signpost 102).

It is to be understood that the diagrams in FIGS. 7A-7C are merely illustrative and should not be interpreted as limiting the scope of the present disclosure. The electronic reservation system 100 may provide comprehensive functionality for both campers 106 and proprietors 108 throughout the entire reservation lifecycle. Potential campers 106 may view the web application to view available sites in real-time, potentially providing immediate access to current campsite availability without requiring physical inspection of individual sites. When a potential camper 106 arrives at the campsite and approaches the signpost with the vacancy indicator, they may seamlessly interact with the system using either the web application or a dedicated mobile app. The camper 106 may identify the specific site through a combination of site numbers and QR codes (which may be provided on a printed sign or a display device), or alternatively via Bluetooth Low Energy (BLE) advertisement that may automatically detect their proximity to the signpost. In some embodiments, active or passive near-field communication (NFC) may be used as an alternative to QR codes for identification, check-in, access, or interactions with the signpost 102. For example, a camper 106 may tap a mobile device equipped with NFC capabilities against an NFC reader integrated into the signpost 102 to initiate a reservation process, complete a check-in procedure, or access campsite-specific information. Once the site is identified, the website may confirm real-time availability, and in some embodiments, payment links may be sent to campers 106 after dates and site selections are made, allowing the camper 106 to complete the payment process through a secure link delivered via SMS or email. The website may securely process payment from the camper, potentially eliminating the traditional cash-only or check-based payment limitations of conventional iron ranger systems. Upon successful payment processing, the website may signal the edge device to become registered and activate associated services by maintaining a unique reservation token, which may serve as a digital key for later site management and eventual check-out procedures. In some embodiments, the signposts 102 may support a variety of operational functions including registration of new reservations, purchasing registrations or other items such as firewood or amenity passes, check-in and check-out procedures, initiating communication with campground staff through messaging interfaces, and purchasing additional items during a stay such as reservation extensions or additional services. In some embodiments, signposts or sensing devices may be linked to specific campsites through the web application with appropriate permissions, allowing campground administrators to configure which signpost 102 is associated with which campsite. The signs or sensors may be re-assigned or re-linked to different campsites as needed, providing flexibility in campground management when campsites are reconfigured, when equipment is replaced or upgraded, or when temporary signposts are deployed for special events.

The electronic reservation system 100 may provide automated reservation management features that may enhance the camping experience while potentially reducing administrative burden. For example, campers 106 may receive automated email notifications on the morning of their last reserved day, potentially offering the opportunity to extend their stay if campground policy permits and sites remain available. In some embodiments, group or bulk site offers may be sent by campground staff to coordinate group camping events, or may be initiated by campers 106 who are coordinating group camping and wish to reserve multiple adjacent or nearby campsites. For example, a camper 106 organizing a family reunion may request a bulk reservation for multiple campsites, and the system may generate a group offer that allows multiple participants to claim individual campsites within the group reservation while maintaining linkage between the reservations. The web application may intelligently manage these extension requests by either processing the extended reservation with additional payment or scheduling the automatic deregistration of services using the appropriate reservation token. Check-out procedures may be similarly automated, with services potentially being deactivated at the time determined by the proprietor's established policies. Following departure, campers 106 may receive confirmation emails that may provide opportunities for feedback, including stay evaluations, problem reporting, and rating systems that may help proprietors improve their facilities and services. This automated communication system may ensure consistent follow-up while potentially maintaining detailed records of guest experiences and site utilization patterns.

Proprietors 108 may benefit from comprehensive management and monitoring capabilities through the web application interface. They may monitor real-time status of campsite vacancy and other critical properties, potentially providing immediate visibility into occupancy rates, revenue generation, and site utilization patterns across their entire facility. The system may enable proprietors 108 to communicate effectively with registered users through both mass messaging capabilities for campground-wide announcements (such as weather alerts, facility maintenance notices, or special events) and individual messaging for personalized guest services or issue resolution. Additionally, proprietors 108 may override automated system behavior when necessary, such as manually blocking sites for maintenance, extending grace periods for late departures, or accommodating special circumstances that may require human intervention. In some embodiments, special events may be declared that affect one or more campsites, modifying campsite properties and controlling access through the registration system. For example, a proprietor 108 may declare a special event such as a music festival, holiday celebration, or maintenance period that affects a designated area of the campground, and the system may automatically adjust pricing, availability, reservation rules, or access permissions for the affected campsites during the event period. In some embodiments, policies may influence automated behavior such as check-in rules that specify earliest check-in times or require on-site verification, special-event rules that modify standard reservation procedures during designated events, or occupancy limits that restrict the number of occupants or vehicles permitted at each campsite. Authorized staff may override automated behaviors when needed to accommodate exceptional circumstances, such as allowing early check-in for a camper 106 who has experienced travel difficulties, extending a reservation beyond standard limits for a camper 106 with special needs, or manually adjusting pricing for promotional purposes. The system may also provide comprehensive reporting functionality, potentially allowing proprietors 108 to access detailed analytics on reservation patterns, revenue trends, peak usage periods, and operational metrics that may inform business decisions and facility improvements.

In some embodiments, the electronic reservation system 100 may provide arrival and departure awareness capabilities along with courtesy notifications to enhance safety and coordination among campers 106 and campground staff. The system may detect when a camper 106 is arriving at or approaching a campsite through various mechanisms such as GPS location data from a mobile device, check-in actions performed through the interaction application 504, detection of vehicle presence by parking pad sensors, or detection of power usage initiation by the power monitoring circuitry 110. Similarly, the system may detect when a camper 106 is departing or checking out through check-out actions performed through the interaction application 504, cessation of power usage, or absence of vehicle presence detected by sensors. In some embodiments, arrival notifications may be sent to nearby campers 106 to inform them of new neighbors arriving at adjacent or nearby campsites, to incoming campers 106 to confirm that their reserved campsite is ready for occupancy, to campground staff to enable them to provide welcome services or verify proper check-in procedures, and to members of linked group reservations to coordinate arrival times and facilitate group gatherings. In some embodiments, departure notifications may be sent to incoming campers 106 who have reservations for the same campsite to inform them when the site becomes available, to nearby campers 106 to inform them of departing neighbors, and to campground staff for turnover operations such as site inspection, cleaning, or maintenance activities that may be required between reservations. The system may identify potential conflicts such as overlapping arrivals and departures when an incoming camper 106 is scheduled to arrive before a departing camper 106 has completed check-out, or simultaneous vehicle movements near a site when multiple campers 106 in adjacent campsites are arriving or departing at similar times, which may create congestion or safety concerns. In some embodiments, courtesy alerts may be sent to help avoid collisions or congestion, including slow-down warnings when vehicle traffic is detected in areas with limited visibility or narrow roads, quiet-hours reminders when campers 106 are active during designated quiet periods, and path-traffic notifications when pedestrian or vehicle traffic is detected on shared pathways or access roads. The system may provide event-triggered courtesy messages such as reminders about quiet hours before the designated quiet period begins, parking reminders when vehicles are detected in unauthorized locations, or safety notices when weather conditions or wildlife activity may pose risks to campers 106. In some embodiments, arrival and departure events may be logged and associated with user accounts to maintain a history of each camper's 106 arrival and departure patterns, with reservations to track compliance with scheduled check-in and check-out times, and with historical campsite records to identify patterns such as frequent early departures or late arrivals that may indicate issues with specific campsites or areas of the campground.

The electronic reservation system 100 incorporates advanced safety and operational features that extend beyond basic reservation management. Emergency alert capabilities allow both campers 106 and proprietors 108 to directly request assistance from authorities, while automated monitoring can trigger alerts based on predefined policy parameters, such as unusual power consumption patterns, extended periods of inactivity, or environmental sensor readings that indicate potential safety concerns. The system provides sophisticated site control mechanisms through both process variables and configurable policies, enabling dynamic management of site availability based on factors such as weather conditions, maintenance schedules, or special events. Additional technical capabilities include remote software updates for control units in embodiments with electronic components, ensuring system security and functionality improvements without requiring physical site visits, password-less secure check-in procedures that enhance user convenience while maintaining security, and retrofit capability that allows integration with existing campground infrastructure. The system also supports location-based check-in policies that require users to be physically present at their reserved site, visual availability indicators that provide immediate status information (whether through printed signs or display devices), presence detection capabilities, comprehensive on-site environmental measurements, and robust edge system functionality that maintains critical operations during network outages or power failures, ensuring continuous service availability even under adverse conditions.

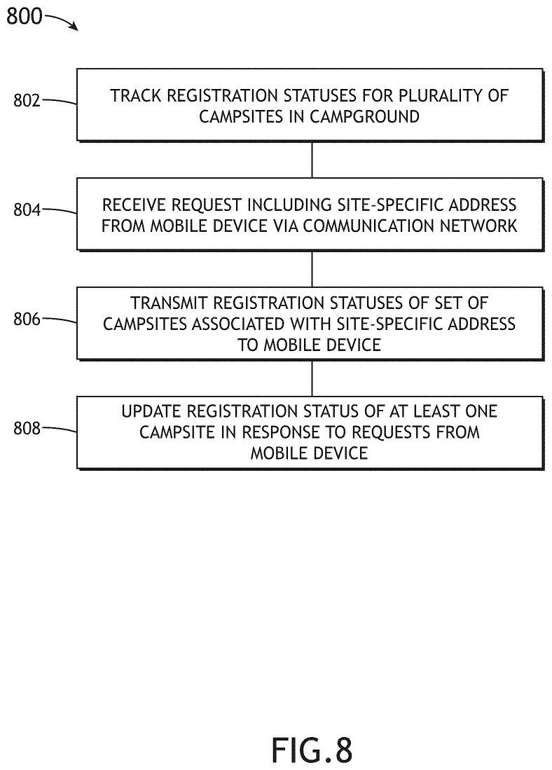

Referring now to FIGS. 8-11, various operational flows are described, in accordance with one or more embodiments of the present disclosure. The embodiments and enabling technologies described in the context of the electronic reservation system 100 may be extended to the methods below. However, the methods below are not limited to the architecture of the electronic reservation system 100.

FIG. 8 illustrates a flowchart for method 800 for managing campsites in a campground, in accordance with one or more embodiments of the present disclosure.

In some embodiments, the method 800 may include a step 802 of tracking registration statuses for a plurality of campsites in the campground. The registration controller 104 maintains current registration status information for each campsite in the campground, where the registration status for a particular campsite may include registration statuses such as, but not limited to, an available condition indicating that the particular campsite is registrable, an occupied condition indicating that the particular campsite is currently in use, a reserved condition indicating that the particular campsite is unoccupied but has been paid for or has a future reservation, and an unavailable condition indicating that the particular campsite is closed. The registration controller 104 may store this information in memory 306 and continuously update the registration statuses based on user interactions, occupancy detection from sensors 214, power monitoring circuitry 110, or manual updates from proprietors 108. For example, when a camper 106 completes a reservation through the interaction application 504, the registration controller 104 may update the associated campsite from the available condition to the reserved condition or occupied condition depending on the timing of the reservation.

In some embodiments, the method 800 may include a step 804 of receiving a request including a site-specific address from a mobile device via a communication network. When a user scans a QR code, accesses a URL, or otherwise interacts with a site-specific address provided by a signpost 102, their mobile device sends a request to the registration controller 104 via the communication network 116. The site-specific address serves as an identifier that associates the request with one or more specific campsites in the campground. For example, a camper 106 may scan a QR code displayed on a signpost 102 at Site 34, causing their mobile device to send a request including the site-specific address for that particular campsite to the registration controller 104 through cellular networks or WiFi connectivity forming part of the communication network 116.

In some embodiments, the method 800 may include a step 806 of transmitting registration statuses of a set of campsites associated with the site-specific address to the mobile device. Upon receiving the request with the site-specific address, the registration controller 104 identifies which campsite or group of campsites corresponds to that site-specific address and retrieves the current registration status information for those campsites. The registration controller 104 then transmits this information back to the mobile device via the communication network 116, allowing the user to view the current availability and status of the relevant campsites. For example, if the site-specific address corresponds to a single campsite, the registration controller 104 may transmit information indicating whether that campsite has an available condition, occupied condition, reserved condition, or unavailable condition. If the site-specific address corresponds to a group of campsites such as a loop or cluster, the registration controller 104 may transmit a list or map showing the registration status of all campsites in that group.

In some embodiments, the method 800 may include a step 808 of updating the registration status of at least one campsite in response to requests from the mobile device. After receiving the registration status information, the user may interact with the system through their mobile device to perform various actions that modify the registration status of one or more campsites. For example, the mobile device may send additional requests to the registration controller 104 containing the user's desired actions, such as creating a new reservation, modifying an existing reservation, completing check-in or check-out procedures, or making payments. The registration controller 104 may process these requests and update the registration status accordingly. For example, when a camper 106 successfully completes a reservation and payment process for an available campsite, the registration controller 104 updates that campsite's registration status from the available condition to the reserved condition or occupied condition. The updated registration status may then be communicated to the associated signpost 102 to update the display 202 with current information when present, and the distributed logging system 506 may record the transaction for tracking and reporting purposes.

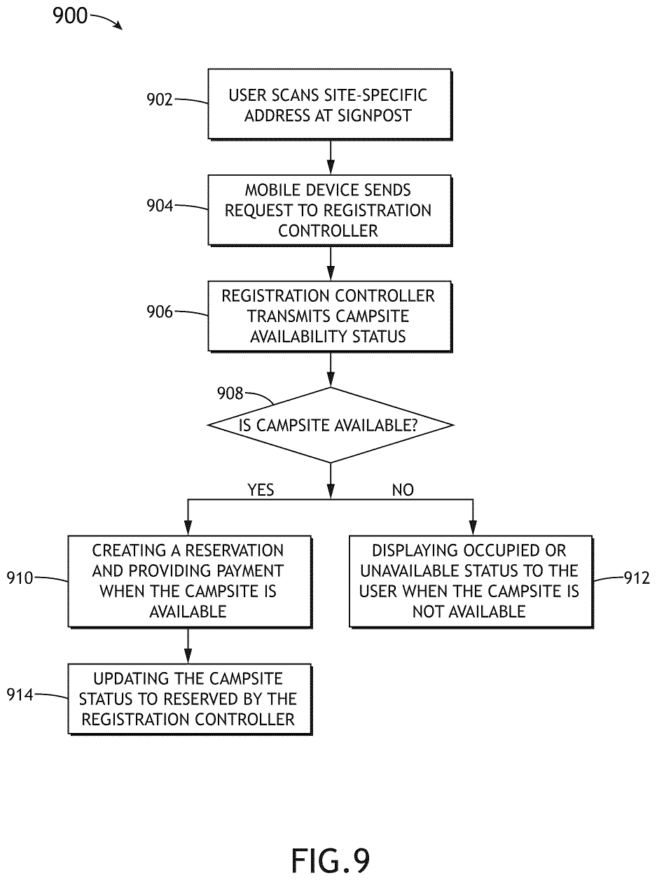

FIG. 9 illustrates a flowchart for a method 900 for user interaction with the campsite reservation system using electronic signposts, in accordance with one or more embodiments of the present disclosure. The method 900 may provide a nonlimiting example implementation of the method 800.

In some embodiments, the method 900 may include a step 902 of scanning a site-specific address at a signpost. A user such as a camper 106 physically approaches a signpost 102 located at or near a campsite and uses their mobile device to scan or otherwise access the site-specific address provided by the signpost 102. The site-specific address may include a QR code displayed on a printed sign or on a display 202, a URL, a Bluetooth Low Energy (BLE) identifier, or other machine-readable or human-readable identifier. For example, a camper 106 may use their smartphone camera to scan a QR code displayed on the signpost 102 at Site 34, which contains encoded information linking to the interaction application 504 and identifying the specific campsite.

In some embodiments, the method 900 may include a step 904 of sending a request to a registration controller from the mobile device. For example, step 904 may initiate step 804 of method 800, where the registration controller receives request including the site-specific address is from the mobile device via the communication network. After scanning or accessing the site-specific address, the mobile device automatically or upon user confirmation may send a request including the site-specific address to the registration controller 104 via the communication network 116. This request serves to identify which campsite or group of campsites the user is interested in and initiates communication between the mobile device and the electronic reservation system 100. For example, when the camper 106 scans the QR code, their mobile device may automatically open a web browser or mobile application and send an HTTP request containing the site-specific address to the registration controller 104 through cellular networks or WiFi connectivity.

In some embodiments, the method 900 may include a step 906 of transmitting campsite availability status (or registration status more generally) to the mobile device from the registration controller. The step 906 may thus correspond to step 806 of the method 800. Upon receiving the request with the site-specific address, the registration controller 104 identifies the campsite or group of campsites associated with that address, retrieves the current registration status information from memory 306, and transmits this information back to the mobile device via the communication network 116. The transmitted information includes whether the campsite has an available condition, occupied condition, reserved condition, or unavailable condition, along with any relevant details such as reservation durations or closure periods. For example, the registration controller 104 may respond with information indicating that Site 34 has an available condition and is ready for immediate reservation, or that it has an occupied condition until a specific date and time.

In some embodiments, the method 900 may include a step 908 of determining whether the campsite is available. For example, the step 908 may utilize the registration statuses tracked in step 802 of the method 800. This decision point evaluates the registration status information received from the registration controller 104 to determine the appropriate next steps in the user interaction flow. The mobile device or interaction application 504 presents the availability status to the user and determines whether the campsite can be reserved immediately. If the campsite has an available condition, the method 900 proceeds along the “Yes” branch to enable reservation creation. If the campsite has an occupied condition, reserved condition, or unavailable condition, the method 900 proceeds along the “No” branch to display appropriate status information to the user.

In some embodiments, the method 900 may include a step 910 of creating a reservation and providing payment when the campsite is available. When the campsite is determined to be available, the user may proceed through the interaction application 504 to select reservation dates, specify the number of nights, provide personal information, and complete payment processing. The interaction application 504 guides the user through the reservation process, which may include selecting check-in and check-out dates, entering contact information, agreeing to campground policies, and providing payment information such as credit card details. For example, the camper 106 may select a three-night stay beginning immediately, enter their email address and phone number, and provide credit card information to complete the reservation and payment process.

In some embodiments, the method 900 may include a step 912 of displaying occupied or unavailable status to the user when the campsite is not available. When the campsite is determined to be unavailable for reservation, the interaction application 504 presents appropriate status information to inform the user of the current situation. This may include displaying that the campsite is currently occupied with information about when it will become available, that it is reserved with future check-in dates, or that it is closed for maintenance or other reasons. The displayed information may also provide alternative options such as viewing availability for nearby campsites, joining a waitlist for the desired campsite, or receiving notifications when the campsite becomes available. For example, the application may display “SITE OCCUPIED until Sep. 6, 2024 2:00 PM” and offer links to view availability for other campsites in the same loop or area.

In some embodiments, the method 900 may include a step 914 of updating the campsite status to reserved by the registration controller. The step 914 may thus correspond to step 808 of the method 800. When the user successfully completes the reservation and payment process in step 910, the registration controller 104 receives the reservation information and payment confirmation, then updates the registration status of the campsite from the available condition to the reserved condition or occupied condition depending on the timing of the reservation. The registration controller 104 stores the updated status in memory 306, communicates the change to the associated signpost 102 to update any display 202 with current information, and records the transaction in the distributed logging system 506. For example, after the camper 106 completes payment for Site 34, the registration controller 104 updates the campsite status to the occupied condition if the reservation begins immediately, or to the reserved condition if the reservation has a future check-in date, and directs the signpost 102 to display the updated status information.

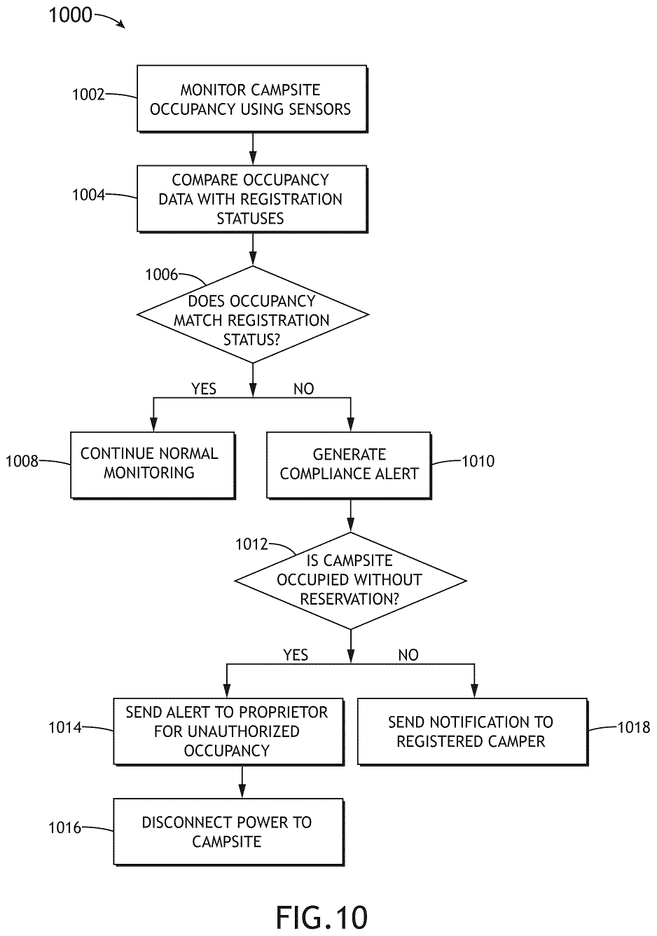

FIG. 10 illustrates a flowchart for a method 1000 for occupancy monitoring in the campsite management system, in accordance with one or more embodiments of the present disclosure.

In some embodiments, the method 1000 may include a step 1002 of monitoring campsite occupancy using sensors. The electronic reservation system 100 continuously monitors the occupancy status of campsites through various sensor technologies including power monitoring circuitry 110, parking pad sensors, RF sensors, or other sensors 214 integrated with the signposts 102 or deployed throughout the campground. For example, the power monitoring circuitry 110 may detect electrical power consumption at campsites with power hookups, providing an indication of active occupancy when power draw exceeds predetermined thresholds. As another example, parking pad sensors may detect the presence of vehicles at campsites, while RF sensors may monitor for radio-frequency signals from electronic devices such as smartphones, tablets, or other WiFi-enabled equipment commonly carried by campers 106. The occupancy monitor 114 may thus include data from any combination of sensors 214 to provide comprehensive occupancy detection capabilities across the campsites.

In some embodiments, the method 1000 may include a step 1004 of comparing occupancy data with registration statuses. The registration controller 104 receives occupancy data from the occupancy monitor 114 and compares this information with the current registration statuses stored in memory 306 for each campsite. This comparison process evaluates whether the detected occupancy status aligns with the expected occupancy based on active reservations and registration records. For example, the registration controller 104 may compare power consumption data indicating active electrical usage at Site 34 with registration data showing that Site 34 has a registration status of the occupied condition with a valid reservation, or may identify a discrepancy when occupancy is detected at a campsite with a registration status of the available condition.

In some embodiments, the method 1000 may include a step 1006 of determining whether occupancy matches the registration status. This decision point evaluates the results of the comparison performed in step 1004 to identify compliance or non-compliance scenarios. When the occupancy data aligns with the registration status, such as when a campsite is occupied and has a valid active reservation with a registration status of the occupied condition, the method 1000 may proceed along the “Yes” branch to continue normal monitoring operations. When discrepancies are identified, such as when a campsite is occupied but has a registration status of the available condition, or when a campsite is vacant despite having a registration status of the occupied condition, the method 1000 may proceed along the “No” branch to initiate compliance alert procedures.

In some embodiments, the method 1000 may include a step 1008 of continuing normal monitoring when occupancy matches the registration status. When the comparison indicates that the detected occupancy status is consistent with the registration records, the electronic reservation system 100 maintains standard monitoring operations without triggering alerts or enforcement actions. The system continues to collect occupancy data from sensors 214, power monitoring circuitry 110, and other detection mechanisms, and periodically repeats the comparison process to ensure ongoing compliance. The distributed logging system 506 may record the compliance status for reporting and analysis purposes, and the method 1000 returns to step 1002 to continue monitoring campsite occupancy.

In some embodiments, the method 1000 may include a step 1010 of generating a compliance alert when occupancy does not match the registration status. When discrepancies are identified between the occupancy data and registration statuses, the registration controller 104 generates compliance alerts to notify appropriate parties and initiate corrective actions. The compliance alert may include information such as the campsite identifier, the nature of the discrepancy, the time the non-compliance was detected, and relevant sensor data. The registration controller 104 may log the compliance alert in the distributed logging system 506 and prepare to send notifications to proprietors 108 or registered campers 106 as appropriate based on the specific type of non-compliance detected.

In some embodiments, the method 1000 may include a step 1012 of determining whether the campsite is occupied without a reservation. This decision point evaluates the specific nature of the non-compliance to determine the appropriate response actions. For example, when the occupancy data indicates that a campsite is occupied but the registration status shows the available condition or the reserved condition with a future check-in date, indicating potential unauthorized use, the method 1000 may proceed along the “Yes” branch to initiate enforcement actions for unauthorized occupancy. When the non-compliance involves other scenarios, such as a campsite being vacant despite having a registration status of the occupied condition, the method 1000 proceeds along the “No” branch to send notifications to the registered camper 106.

In some embodiments, the method 1000 may include a step 1014 of sending an alert to the proprietor for unauthorized occupancy. When unauthorized occupancy is detected, the registration controller 104 sends an immediate alert to the proprietor 108 or campground staff to enable prompt intervention. The alert may include detailed information about the affected campsite, the time unauthorized occupancy was detected, the type of occupancy indicators that triggered the alert (such as power consumption, vehicle presence, or RF activity), and any relevant sensor data that may assist staff in addressing the situation. The alert may be transmitted through various communication channels including email, SMS, or through the interaction application 504 interface used by campground management.

In some embodiments, the method 1000 may include a step 1016 of disconnecting power to the campsite. As an enforcement action for unauthorized occupancy, the registration controller 104 may direct the power distribution circuitry to disconnect electrical power to the affected campsite. This enforcement mechanism discourages continued unauthorized use by removing access to electrical services that many campers 106 rely on for lighting, device charging, and other essential functions. The power disconnection may be implemented through the power distribution circuitry controlling power distribution hookups at the campsite, which may be integrated with the power monitoring circuitry 110 and central power distribution station 112. The system may log the power disconnection action in the distributed logging system 506 and notify the proprietor 108 of the enforcement action taken.

In some embodiments, the method 1000 may include a step 1018 of sending a notification to the registered camper. When the non-compliance involves scenarios other than unauthorized occupancy, such as when a campsite with an active reservation is detected as vacant, the registration controller 104 sends a notification to the registered camper 106 associated with the reservation. This notification may serve various purposes depending on the specific situation, such as reminding the camper 106 of their reservation if they have not yet arrived for a scheduled check-in, requesting confirmation of their continued occupancy if sensors indicate the campsite may be vacant, or providing information about reservation policies if early departure is detected. The notification may be sent through email, SMS, or other communication channels specified in the camper's 106 contact preferences, and may include options for the camper 106 to respond or take corrective actions through the interaction application 504.

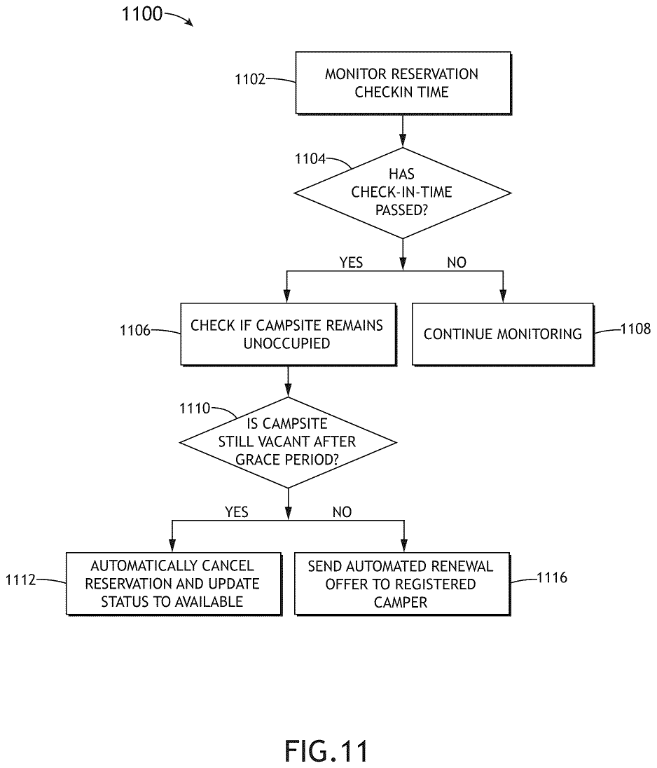

FIG. 11 illustrates a flowchart for method 1100 for automated reservation management, in accordance with one or more embodiments of the present disclosure. The

In some embodiments, the method 1100 may include a step 1102 of monitoring reservation check-in time for campsites with active reservations. The registration controller 104 continuously tracks the scheduled check-in times for all campsites that have active reservations with a registration status of the reserved condition. The registration controller 104 maintains this information in memory 306 and compares the current time with the expected check-in times specified in each reservation. For example, if a camper 106 has reserved Site 34 with a check-in time of 2:00 PM on September 6th, the registration controller 104 monitors the approach of this scheduled time and tracks whether the check-in time has passed without the camper 106 completing the check-in process through the interaction application 504.

In some embodiments, the method 1100 may include a step 1104 of determining whether the check-in time has passed. This decision point evaluates whether the current time has exceeded the scheduled check-in time for a particular reservation. The registration controller 104 compares the current timestamp with the check-in time stored in the reservation data to determine if the expected arrival window has elapsed. If the check-in time has not yet passed, the method 1100 proceeds along the “No” branch to continue monitoring. If the check-in time has passed without the camper 106 completing check-in procedures, the method 1100 proceeds along the “Yes” branch to initiate occupancy verification procedures. For example, if the current time is 3:00 PM and the reservation specified a 2:00 PM check-in time, the registration controller 104 determines that the check-in time has passed and proceeds to verify whether the campsite is actually occupied.

In some embodiments, the method 1100 may include a step 1106 of checking if the campsite remains unoccupied. When the check-in time has passed, the registration controller 104 analyzes occupancy data from various sensors to determine whether the campsite is actually being used despite the lack of formal check-in. The registration controller 104 receives data from the occupancy monitor 114, which aggregates information from power monitoring circuitry 110, parking pad sensors, RF sensors, or other sensors 214 associated with the campsite. This analysis determines whether the camper 106 may have arrived and begun using the campsite without completing the digital check-in process, or whether the campsite remains genuinely vacant. For example, the registration controller 104 may detect that power consumption at Site 34 has increased above baseline levels, indicating that the camper 106 has arrived and connected electrical devices, even though they have not yet completed check-in through the interaction application 504.

In some embodiments, the method 1100 may include a step 1108 of continuing to monitor the reservation status when the check-in time has not passed. When the scheduled check-in time has not yet been reached, the registration controller 104 maintains normal monitoring operations without triggering any alerts or automated actions. The system continues to track the approaching check-in time and maintains the campsite's registration status as the reserved condition. The registration controller 104 may continue to accept check-in requests from the registered camper 106 through the interaction application 504 and returns to step 1102 to continue monitoring the reservation check-in time. For example, if a reservation has a check-in time of 2:00 PM and the current time is 1:30 PM, the registration controller 104 continues normal monitoring operations and waits for either the camper 106 to complete check-in or for the scheduled time to pass.

In some embodiments, the method 1100 may include a step 1110 of determining whether the campsite is still vacant after a grace period. This decision point implements a grace period that allows for reasonable delays in camper 106 arrival or check-in completion before taking automated actions. The registration controller 104 waits for a predetermined grace period (such as one hour, two hours, or any suitable duration configured by the proprietor 108) after the scheduled check-in time before determining that the reservation should be considered a no-show. During this grace period, the registration controller 104 continues to monitor for occupancy indicators and check-in completion. If occupancy is detected or check-in is completed during the grace period, the method 1100 proceeds along the “No” branch to send renewal offers. If the campsite remains vacant and no check-in occurs after the grace period expires, the method 1100 proceeds along the “Yes” branch to automatically cancel the reservation. For example, if the check-in time was 2:00 PM and the grace period is two hours, the registration controller 104 waits until 4:00 PM before determining whether to cancel the reservation or send renewal offers.

In some embodiments, the method 1100 may include a step 1112 of automatically canceling the reservation and updating the campsite status to available. When the campsite remains vacant after the grace period and no check-in has been completed, the registration controller 104 automatically cancels the reservation to make the campsite available for new reservations. The registration controller 104 updates the registration status of the campsite from the reserved condition to the available condition, processes any applicable refunds or cancellation fees according to campground policies, and records the cancellation in the distributed logging system 506. The registration controller 104 may also send a cancellation notification to the original camper 106 explaining that their reservation has been automatically cancelled due to non-arrival. If the campsite has a display 202, the associated signpost 102 is directed to update the display to show the available condition. For example, if Site 34 remains vacant and no check-in occurs by 4:00 PM for a 2:00 PM reservation, the registration controller 104 cancels the reservation, updates the campsite status to available, and directs the signpost 102 to display availability information for walk-in campers.

In some embodiments, the method 1100 may include a step 1116 of sending an automated renewal offer to the registered camper. When occupancy is detected during or after the grace period, indicating that the camper 106 has arrived and is using the campsite, the registration controller 104 sends an automated message to facilitate completion of the check-in process or extension of the reservation. This automated renewal offer may include a link to complete the delayed check-in through the interaction application 504, options to extend the current reservation for additional nights, reminders about campground policies and check-in requirements, or payment processing for any additional fees that may apply due to late check-in. The renewal offer provides an opportunity for the camper 106 to regularize their reservation status and continue their stay in compliance with campground policies. For example, if power consumption and vehicle presence are detected at Site 34 after the grace period, the registration controller 104 may send an SMS message to the registered camper 106 with a link to complete check-in and options to extend their stay, along with information about any late check-in fees that may apply according to campground policies.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A campsite management system comprising:
one or more signposts configured to be located in a campground including a plurality of campsites, wherein each signpost of the one or more signposts provides a site-specific address associated with a set of one or more campsites of the plurality of campsites; and
a registration controller configured to be communicatively coupled with a communication network, wherein the registration controller includes one or more processors configured to execute program instructions causing the one or more processors to:
track registration statuses for the plurality of campsites, wherein the registration status for a particular campsite of the plurality of campsites includes at least an available condition indicating that the particular campsite is registrable, an occupied condition indicating that the particular campsite is currently in use, a reserved condition indicating that the particular campsite is unoccupied but has been paid for or has a future reservation, and an unavailable condition indicating that the particular campsite is closed;
receive, from a mobile device of a user via the communication network, a request including the site-specific address of a particular signpost of the one or more signposts;
transmit, to the mobile device via the communication network, the registration statuses of the set of one or more campsites associated with the site-specific address; and
update the registration status of at least one campsite of the set of one or more campsites associated with the site-specific address in response to one or more requests received from the mobile device via the communication network.

2. The campsite management system of claim 1, wherein a particular signpost includes a display device configured to be communicatively coupled with the communication network.

3. The campsite management system of claim 2, wherein the program instructions further cause the one or more processors of the registration controller to direct the display device to display the registration statuses for the set of one or more campsites associated with the particular signpost.

4. The campsite management system of claim 2, wherein the display device displays the site-specific address of the particular signpost.

5. The campsite management system of claim 1, wherein updating the registration status comprises:
at least one of registering, checking in to an existing reservation, or checking out.

6. The campsite management system of claim 1, wherein the program instructions further cause the one or more processors of the registration controller to accept payment via the mobile device of the user.

7. The campsite management system of claim 5, wherein the registration controller communicates with the mobile device through an internet portal via the communication network.

8. The campsite management system of claim 7, wherein the internet portal comprises at least one of a website or an application executable on the mobile device.

9. The campsite management system of claim 1, wherein a particular signpost includes a communication system configured to communicate with the registration controller via the communication network.

10. The campsite management system of claim 9, wherein the communication system comprises a cellular radio.

11. The campsite management system of claim 1, wherein the communication network includes a gateway located in the campground, wherein the particular signpost communicates with the gateway via a first communication channel, wherein the gateway communicates with the registration controller via a second communication channel.

12. The campsite management system of claim 11, wherein the first communication channel comprises at least one of a WiFi communication channel, a LoRA communication channel, or a wired communication channel.

13. The campsite management system of claim 11, wherein the second communication channel comprises a cellular communication channel.

14. The campsite management system of claim 1, further comprising:
power monitoring circuitry configured to monitor power consumption at one or more campsites of the plurality of campsites, wherein the power monitoring circuitry provides power consumption data to the registration controller.

15. The campsite management system of claim 1, further comprising:
one or more sensors associated with one or more campsites of the plurality of campsites, wherein the one or more sensors are configured to detect occupancy of the one or more campsites and provide occupancy data to the registration controller.

16. The campsite management system of claim 15, wherein the one or more sensors comprise at least one of power monitoring circuitry configured to monitor power consumption, a parking pad sensor configured to detect vehicle presence, a radio-frequency sensor configured to detect radio-frequency signals from electronic devices, a motion sensor, a camera, or a temperature sensor.

17. The campsite management system of claim 15, wherein the one or more processors are further configured to execute program instructions causing the one or more processors to:
compare the occupancy data with the registration statuses for the plurality of campsites; and
generate an alert when the occupancy data indicates that a particular campsite is occupied and the registration status for the particular campsite indicates the available condition or the reserved condition with a future check-in date.

18. The campsite management system of claim 15, further comprising power distribution circuitry at one or more campsites of the plurality of campsites, wherein the one or more processors are further configured to direct the power distribution circuitry to selectively provide power to a particular campsite when the particular campsite has a registration status of the occupied condition or the reserved condition with a current check-in date.

19. The campsite management system of claim 1, wherein the program instructions further cause the one or more processors of the registration controller to:
send automated notifications to a registered user associated with a particular campsite, wherein the automated notifications include at least one of a check-in reminder, a check-out reminder, a reservation extension offer, or a renewal follow-up message.

20. The campsite management system of claim 1, wherein the program instructions further cause the one or more processors of the registration controller to:
automatically cancel a reservation for a particular campsite when the particular campsite remains unoccupied beyond a grace period following an expected check-in time; and
update the registration status of the particular campsite from the reserved condition to the available condition.

21. The campsite management system of claim 1, wherein the one or more processors are further configured to execute program instructions causing the one or more processors to:
monitor a check-in time for a particular campsite having the reserved condition;
when the check-in time has passed without check-in completion, determine whether the particular campsite remains unoccupied; and
when the particular campsite remains unoccupied beyond a grace period beyond the check-in time, automatically cancel a reservation for the particular campsite and update the registration status from the reserved condition to the available condition.

22. A registration controller for managing campsites in a campground, the registration controller comprising:
one or more processors configured to execute program instructions causing the one or more processors to:
track registration statuses for a plurality of campsites in the campground, wherein the registration status for a particular campsite of the plurality of campsites includes at least an available condition indicating that the particular campsite is registrable, an occupied condition indicating that the particular campsite is currently in use, a reserved condition indicating that the particular campsite is unoccupied but has been paid for or has a future reservation, and an unavailable condition indicating that the particular campsite is closed;
receive, from a mobile device of a user via a communication network, a request including a site-specific address associated with a set of one or more campsites of the plurality of campsites, wherein the site-specific address is provided by a signpost located in the campground;
transmit, to the mobile device via the communication network, the registration statuses of the set of one or more campsites associated with the site-specific address; and
update the registration status of at least one campsite of the set of one or more campsites associated with the site-specific address in response to one or more requests received from the mobile device via the communication network.

23. A registration controller for managing campsites in a campground, the registration controller including one or more processors configured to execute program instructions causing the one or more processors to:
monitor occupancy of a plurality of campsites using one or more sensors;
compare occupancy data from the one or more sensors with registration statuses for the plurality of campsites; and
when the occupancy data indicates that a particular campsite of the plurality of campsites is occupied but not reserved, generate at least one of a compliance alert or direct power distribution circuitry to disconnect electrical power to the particular campsite.
